(19) United States
(12) Patent Application Publication
(10) Pub. No.: US 2025/0243878 A1
(43) Pub. Date: Jul. 31, 2025

(54) MODULAR RESTRICTOR FOR A DYNAMIC FAN MOUNT

(71) Applicant: Delta T, LLC, Lexington, KY (US)

(72) Inventors: Jason Fizer, Lexington, KY (US); Michael Smith, Lexington, KY (US); Mark Figan, Lexington, KY (US)

(21) Appl. No.: 19/040,128

(22) Filed: Jan. 29, 2025

Related U.S. Application Data
(60) Provisional application No. 63/626,266, filed on Jan. 29, 2024.

(51) Int. Cl. F04D 29/64; F04D 25/08

(52) U.S. Cl. CPC F04D 29/644; F04D 25/088

(57) ABSTRACT

A dynamic fan mount for supporting the fan has a first part movable relative to a second part. A modular restrictor restricts lateral movement or swaying of the fan. In one embodiment, the modular restrictor is formed of two portions, which may be interconnected by a fastener, and one of which includes a channel in communication with a central passage. Related methods are also disclosed.

This application claims the benefit of U.S. Provisional Patent Application Ser. No. 63/626,266, filed Jan. 29, 2024, the disclosure of which is incorporated herein by reference.

### TECHNICAL FIELD

This document relates generally to the air circulating fan arts and, in particular, a dynamic fan mount with a modular restrictor.

### BACKGROUND

A variety of fan systems have been made and used over the years in a variety of contexts. For instance, various ceiling fans are disclosed in U.S. Pat. No. 7,284,960, entitled “Fan Blades,” issued Oct. 23, 2007; U.S. Pat. No. 6,244,821, entitled “Low Speed Cooling Fan,” issued Jun. 12, 2001; U.S. Pat. No. 6,939,108, entitled “Cooling Fan with Reinforced Blade,” issued Sep. 6, 2005; and U.S. Pat. No. D607,988, entitled “Ceiling Fan,” issued Jan. 12, 2010. The disclosures of each of those U.S. patents are incorporated by reference herein. Additional exemplary fans are disclosed in U.S. Pat. No. 8,079,823, entitled “Fan Blades,” issued Dec. 20, 2011; U.S. Pat. Pub. No. 2009/0208333, entitled “Ceiling Fan System with Brushless Motor,” published Aug. 20, 2009; and U.S. Pat. Pub. No. 2010/0278637, entitled “Ceiling Fan with Variable Blade Pitch and Variable Speed Control,” published Nov. 4, 2010, the disclosures of which are also incorporated by reference herein. It should be understood that teachings herein may be incorporated into any of the fans described in any of the above-referenced patents, publications, or patent applications.

A fan blade or airfoil may include one or more upper air fences and/or one or more lower air fences at any suitable position(s) along the length of the fan blade or airfoil. Merely exemplary air fences are described in U.S. Pat. Pub. No. 2011/0081246, entitled “Air Fence for Fan Blade,” published Apr. 7, 2011, the disclosure of which is incorporated by reference herein. Alternatively, any other suitable type of component or feature may be positioned along the length of a fan blade or airfoil; or such components or features may simply be omitted.

The outer tip of a fan blade or airfoil may be finished by the addition of an aerodynamic tip or winglet. Merely exemplary winglets are described in U.S. Pat. No. 7,252,478, entitled “Fan Blade Modifications,” issued Aug. 7, 2007, the disclosure of which is incorporated by reference herein. Additional winglets are described in U.S. Pat. No. 7,934,907, entitled “Cuffed Fan Blade Modifications,” issued May 3, 2011, the disclosure of which is incorporated by reference herein. Still other exemplary winglets are described in U.S. Pat. No. D587,799, entitled “Winglet for a Fan Blade,” issued Mar. 3, 2009, the disclosure of which is incorporated by reference herein. In some settings, such winglets may interrupt the outward flow of air at the tip of a fan blade, redirecting the flow to cause the air to pass over the fan blade in a perpendicular direction, and also ensuring that the entire air stream exits over the trailing edge of the fan blade and reducing tip vortex formation. In some settings, this may result in increased efficiency in operation in the region of the tip of the fan blade. In other variations, an angled extension may be added to a fan blade or airfoil, such as the angled airfoil extensions described in U.S. Pat. Pub. No. 2008/0213097, entitled “Angled Airfoil Extension for Fan Blade,” published Sep. 4, 2008, and issued Apr. 24, 2012 as U.S. Pat. No. 8,162,613, the disclosure of which is incorporated by reference herein. Other suitable structures that may be associated with an outer tip of an airfoil or fan blade will be apparent to those of ordinary skill in the art. Alternatively, the outer tip of an airfoil or fan blade may be simply closed (e.g., with a cap or otherwise, etc.), or may lack any similar structure at all.

The interface of a fan blade and a fan hub may also be provided in a variety of ways. For instance, various interfaces are described in U.S. Pat. Pub. No. 2009/0081045, entitled “Aerodynamic Interface Component for Fan Blade,” published Mar. 26, 2009 and issued Apr. 3, 2012 as U.S. Pat. No. 8,147,204; and U.S. Provisional Patent App. No. 61/590,469, entitled “Fan with Resilient Hub,” filed Jan. 25, 2012, the disclosure of which is incorporated by reference herein. In addition, or in the alternative, the fan blade may include a retention system that couples the tip of a fan blade to an attachment point on the fan hub via a cable running through the fan blade, such as that disclosed in U.S. Pat. Pub. No. 2011/0262278, entitled “Fan Blade Retention System,” published Oct. 27, 2011. Alternatively, the interface of a fan blade and a fan hub may include any other component or components, or may lack any similar structure at all.

It should also be understood that a fan may include sensors or other features that are used to control, at least in part, operation of a fan system. For instance, such fan systems are disclosed in U.S. Pat. Pub. No. 2009/0097975, entitled “Ceiling Fan with Concentric Stationary Tube and Power-Down Features,” published Apr. 16, 2009, and issued Apr. 3, 2012 as U.S. Pat. No. 8,147,182, the disclosure of which is incorporated by reference herein; U.S. Pat. Pub. No. 2009/0162197, entitled “Automatic Control System and Method to Minimize Oscillation in Ceiling Fans,” published Jun. 25, 2009, and issued Feb. 28, 2012 as U.S. Pat. No. 8,123,479, the disclosure of which is incorporated by reference herein; U.S. Pat. Pub. No. 2010/0291858, entitled “Automatic Control System for Ceiling Fan Based on Temperature Differentials,” published Nov. 18, 2010, the disclosure of which is incorporated by reference herein; and U.S. Provisional Patent App. No. 61/165,582, entitled “Fan with Impact Avoidance System Using Infrared,” filed Apr. 1, 2009, the disclosure of which is incorporated by reference herein. Alternatively, any other suitable control systems/features may be used in conjunction with embodiments described herein.

Fans may also include a variety of mounting structures. For instance, a fan mounting structure is disclosed in U.S. Pat. Pub. No. 2009/0072108, entitled “Ceiling Fan with Angled Mounting,” published Mar. 19, 2009, and issued Apr. 10, 2012 as U.S. Pat. No. 8,152,453, the disclosure of which is incorporated herein. Of course, a fan need not be mounted to a ceiling or other overhead structure, and instead may be mounted to a wall or to the ground. For instance, a fan may be supported on the top of a post that extends upwardly from the ground. Still other mounting structures may be used in conjunction with the embodiments described herein (see, e.g., U.S. Pat. Nos. 10,851,939 and 11,118,730, the disclosures of which are incorporated herein by reference.

While several systems and methods have been made and used for mounting ceiling fan blades, it is believed that no one has made or used the invention described in the appended claims.

### SUMMARY

According to a first aspect of the disclosure, an apparatus for mounting a fan is provided. The apparatus includes a fan mount for supporting the fan, the fan mount comprising a first part movable relative to a second part. A modular restrictor is connected to the second part of the fan mount above the first part for restricting the movement of the fan relative to the fan mount. The modular restrictor comprises first and second interconnected portions adapted for engaging the second part.

In one embodiment, the first part comprises a partially spherical ball, the second part comprises a socket for at least partially receiving the partially spherical ball, and the modular restrictor being positioned in the fan mount for engaging an upper surface of the partially spherical ball. Each portion of the restrictor may include at least one passage for receiving a fastener, and at least one portion of the restrictor may include a channel. Each portion of the restrictor may further include a locator for ensuring proper alignment when assembled.

In these or other embodiments, the second part comprises at least one stanchion, and at least one of the portions of the modular restrictor is adapted for engaging the at least one stanchion. Each portion of the modular restrictor may be generally U-shaped in plan view, and may comprise a resilient material.

According to another aspect of the disclosure, an apparatus for mounting a fan includes a fan mount for supporting the fan, the fan mount comprising a first part movable relative to a second part. A modular restrictor is positioned above the first part for restricting the movement of the fan relative to the fan mount. The modular restrictor comprises first and second interconnected portions together forming a central passage for allowing a wire or cable to extend into the fan mount.

In one embodiment, the first part comprises a partially spherical ball and the second part comprises a socket for at least partially receiving the partially spherical ball. The modular restrictor may be positioned in the fan mount for engaging an upper surface of the partially spherical ball. Each portion of the restrictor may include at least one passage for receiving a fastener, and each portion of the restrictor may include a locator for ensuring proper alignment when assembled.

In these or other embodiments, the second part comprises at least one stanchion, and at least one of the portions of the modular restrictor is adapted for engaging the at least one stanchion. At least one portion of the modular restrictor may be generally U-shaped in plan view, and each portion of the modular restrictor is generally U-shaped in plan view. The modular restrictor may comprise a resilient material, and wherein at least one portion of the restrictor may include a channel.

This disclosure also pertains to a method of controlling sway of a fan relative to a fan mount comprising a first part connected to a support for supporting the fan, the first part being movable relative to a second part. The method comprises interconnecting first and second portions of a modular restrictor and positioning the assembled modular restrictor in a position to restrict movement of the first part relative to the second part. The method may further comprise the step of passing wiring through a passage of the modular restrictor. The method may also involve the step of mounting the fan to a ceiling prior to the positioning step.

### BRIEF DESCRIPTION OF THE DRAWINGS

While the specification concludes with claims which particularly point out and distinctly claim this technology, it is believed this technology may be better understood from the following description of certain examples taken in conjunction with the accompanying drawings, in which like reference numerals identify the same elements and in which:

FIG. 1 depicts a schematic view of an exemplary fan mounted to a ceiling with an exemplary ball and socket mounting assembly;

FIG. 2 depicts an exploded perspective view of the ball and socket mounting assembly of FIG. 1;

FIG. 3 is a perspective view of a modular restrictor used in conjunction with the ball and socket mounting assembly of FIGS. 1 and 2;

FIGS. 3A, 3B, and 3C and top and side views of the modular restrictor in combination with the mounting assembly;

FIG. 4 is an exploded perspective view of the modular restrictor used in conjunction with the ball and socket mounting assembly of FIG. 3; and

FIGS. 5 and 6 are perspective view of one portion of the modular restrictor of FIG. 4.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

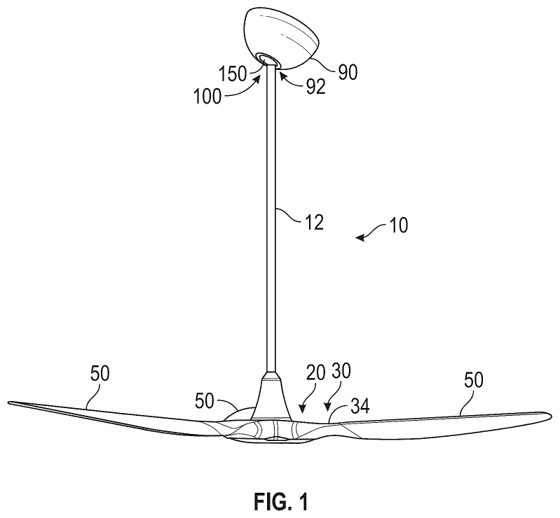

FIG. 1 depicts an exemplary fan (10) having a motor assembly (20), a hub assembly (30) coupled to motor assembly (20), and a plurality of fan blades (50) coupled to hub assembly (30). In the present example, fan (10) (including hub assembly (30) and fan blades (50)) has a diameter of approximately 5 feet. In some versions, fan (10) has a diameter of approximately 7 feet. In other variations, fan (10) has a diameter between approximately 6 feet, inclusive, and approximately 24 feet, inclusive. Further still, fan (10) may have any other suitable dimensions, such as 3 feet, inclusive, to 30 feet, inclusive. Except as otherwise described herein, fan (10) may be constructed and operable in accordance with at least some of the teachings of any of the references that are cited herein; and/or in any other suitable fashion.

Motor assembly (20) is operably coupled to hub assembly (30) such that motor assembly (20) rotates hub assembly (30) relative to motor assembly (20). It should be understood that when fan blades (50) are coupled to hub assembly (30), motor assembly (20) rotates fan blades (50) with hub assembly (30). Motor assembly (20) of the present example comprises a motor (22) and a frame (24). Motor (22) may comprise a permanent magnet brushless DC motor having a drive shaft that is coupled to hub assembly (30), though it should be understood that motor (22) may alternatively comprise any other suitable type of motor (e.g., an AC induction motor, a brushed motor, an inside-out motor, etc.).

By way of example only, motor assembly (20) may be constructed in accordance with at least some of the teachings of U.S. Pat. Pub. No. 2009/0208333, entitled “Ceiling Fan System with Brushless Motor,” published Aug. 20, 2009, the disclosure of which is incorporated by reference herein. Furthermore, fan (10) may include control electronics that are configured in accordance with at least some of the teachings of U.S. Pat. Pub. No. 2010/0278637, entitled “Ceiling Fan with Variable Blade Pitch and Variable Speed Control,” published Nov. 4, 2010, the disclosure of which is incorporated by reference herein. Alternatively, motor assembly (20) may have any other suitable components, configurations, functionalities, and operability, as will be apparent to those of ordinary skill in the art in view of the teachings herein.

In the present example, motor assembly (20) is coupled to a support (12) that is adapted to couple fan (10) to a ceiling or other support structure via ball and socket mounting assembly (100), as will be described in greater detail below. By way of example only, support (12) and/or ball and socket mounting assembly (100) may include features of or be constructed in accordance with at least some of the teachings of U.S. Pat. Pub. No. 2009/0072108, entitled “Ceiling Fan with Angled Mounting,” published Mar. 19, 2009, and issued Apr. 10, 2012 as U.S. Pat. No. 8,152,453, the disclosure of which is incorporated by reference herein, and/or in any other suitable configuration. In some versions, motor assembly (20) may be remote from hub assembly (30) and may be coupled via an axle or other component that is operable to transmit rotational movement from motor assembly (20) to hub assembly (30). Still other configurations will be apparent to one of ordinary skill in the art in view of the teachings herein.

In the present example, a cover (90) substantially shrouds mounting assembly (100) such that only a portion of ball member (150), described in greater detail below, is exposed through cover (90). Cover (90) comprises a substantially hollow hemispherical cover with a central opening (92) to permit a portion of ball member (150) and support (12) to extend therethrough. In some versions, a seal may encircle opening (92) to substantially seal or otherwise limits the passage of material through any gaps between cover (90) and ball member (150). Such a seal may comprise a rubber (natural or synthetic), polymer, felt, or other material annular member that is positioned in or around opening (92). In addition, or in the alternative, the seal may comprise a plurality of fiber strands to form a brush-like ring about ball member (150). The seal may be coupled to cover (90) via a plurality of mechanical fasteners (e.g., screws, bolts, etc.), though this is merely optional. In some versions, the seal may be adhesively attached and/or inserted into a slot or other feature of cover (90) to retain the seal therein. In some versions the seal may be omitted entirely. Of course, still other configurations for cover (90) and/or seal (94) will be apparent to one of ordinary skill in the art in view of the teachings herein.

As demonstrated in the example shown in FIG. 1, ball and socket mounting assembly (100) permits support (12) and fan (10) to pivot about various axes that are perpendicular to the longitudinal axis defined by support (12), such that fan (10) may be mounted to an angled ceiling, such as a cathedral ceiling or other non-level ceiling. Accordingly, fan (10) can substantially self-level via the weight of fan (10) during installation. Support (12) can thus maintain a substantially vertical position when fan (10) is installed.

In some versions, it may be preferable to have fan (10) rotate in substantially all planes of freedom while suspended from a mounting surface (whether angled or otherwise). Such rotation may be accomplished by rotating about a single point. By having a single rotation and attachment point, a decorative cover, such as cover (90), having a very small opening for support (12) may be used while encasing any wiring and electrical connections in an area where fan (10) is attached to a ceiling or other mounting surface.

In some versions, it may be desirable to limit some of the motion about this single point. For example, in a case where fan (10) is imperfectly balanced or where a slight breeze may blow fan (10), fan (10) may sway or oscillate. In such situations, it may be desirable for the mounting assembly of fan (10) to provide a degree of frictional resistance or damping to resist these motions while still retaining the ability to rotate in substantially all planes of freedom while suspended from a mounting surface. Such friction may be provided via ball and socket assembly (100), described below, such that the friction substantially prevents subsequent, inadvertent deviations of support (12) and/or fan (10) from a substantially vertical orientation.

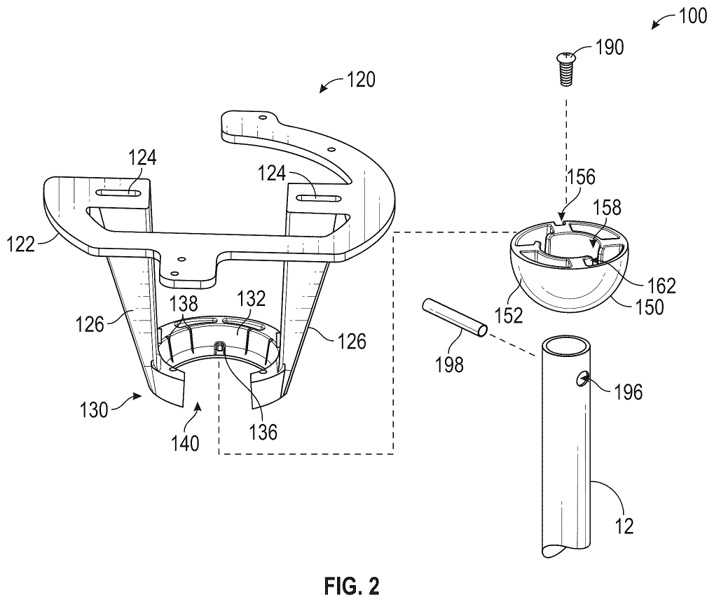

FIG. 2 depicts an exemplary mounting assembly (100) that couples support (12) of fan (10) to a ceiling or other mounting surface. As shown in FIG. 2, the mounting assembly (100) comprises a ball member (150) coupled to support (12). The mounting assembly (100) further includes a mounting portion (120) and a socket portion (130). In the present example, mounting portion (120) comprises a unitary metallic member configured to support fan, though it should be understood that mounting portion (120) may be divided into discrete parts and/or made of other materials (e.g., polymers, ceramics, etc.).

Mounting portion (120) comprises a substantially flat member (122) having one or more openings (124) through which a fastener (e.g., a screw, bolt, etc.) may be inserted to couple mounting portion (120) to a ceiling or other mounting surface. In the present example, openings (124) comprise slots to permit adjustment of the location relative to the ceiling or other mounting surface, though this is optional.

Flat member (122) comprises a substantially C-shaped member, though this is merely optional. In some versions, flat member (122) may be a rectangular, circular, ovular, and/or other plate having any other geometry. In addition, or in the alternative, flat member (122) need not necessarily be flat, but may be curved or have other non-planar features. Such features may be used to conform to a non-flat mounting surface, such as a curved ceiling.

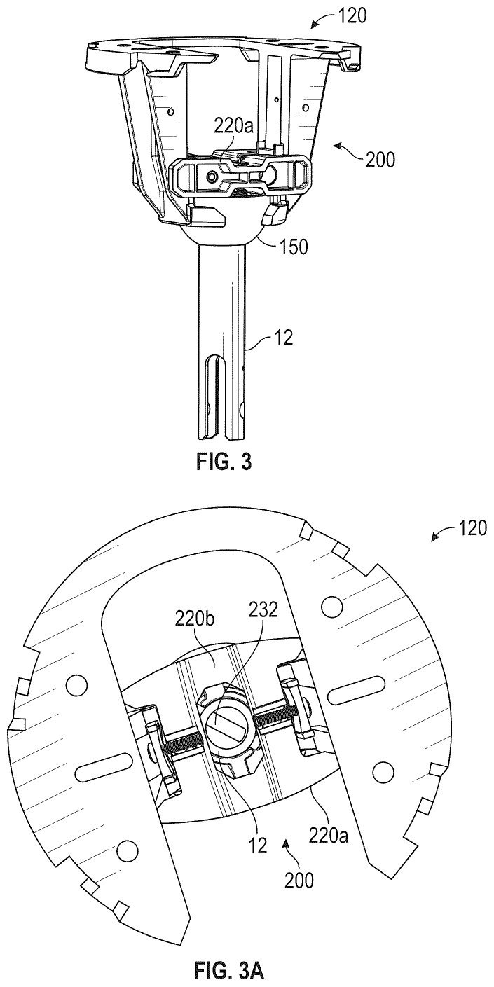

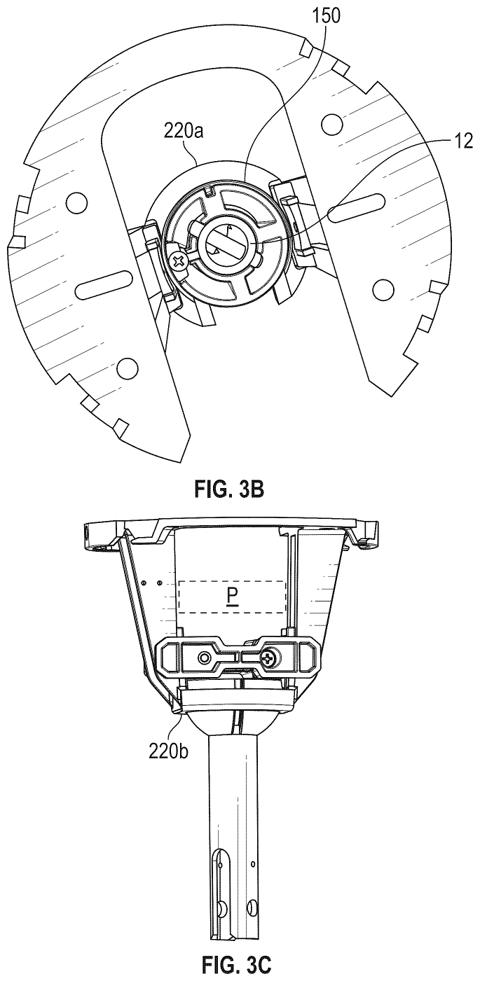

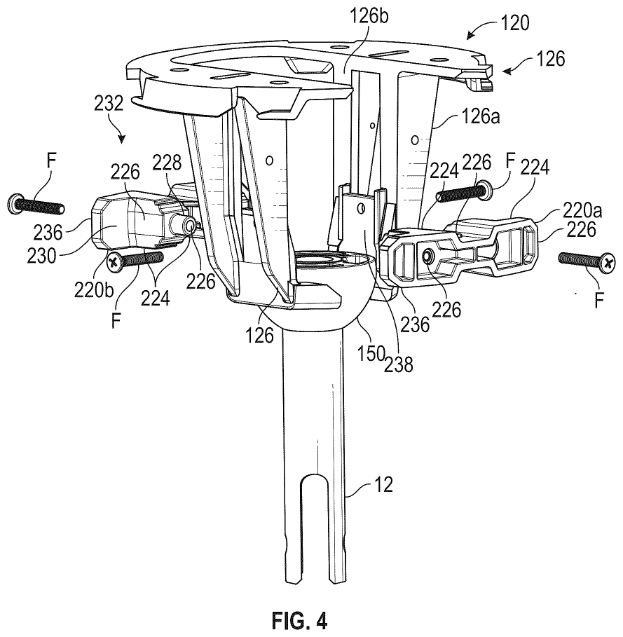

Flat member (122) is offset from socket portion (130) by a pair of stanchions (126). Stanchions (126) extend downwardly from flat member (122). Stanchions (126) terminate at socket portion (130). Although two stanchions (126) are shown in FIG. 2, it may be appreciated that more than two stanchions may be provided (see, e.g., FIGS. 3-4).

In the present example, mounting portion (120) and socket portion (130) are unitary to form a single homogeneous continuum of material, though this is merely optional. In some versions mounting portion (120) is a separate piece that is mechanically or otherwise coupled to socket portion (130). Of course, still other configurations will be apparent to one of ordinary skill in the art in view of the teachings herein.

As shown best in FIG. 2, socket portion (130) comprises a C-shaped member coupled to stanchions (126). In the present example, socket portion (130) has an interior surface (132) configured to receive ball member (150) therein. Socket portion (130) also includes an open section (140) that permits ball member (150) and support (12), described in greater detail below, to be side loaded into socket portion (130) by passing support (12) through open section (140), though this is merely optional. In some versions, socket portion (130) may form a continuous annular member without open section (140).

In the present example, interior surface (132) comprises a conical inwardly tapered surface. The conical taper of interior surface (132) comprises a substantially constant angle of taper. The angle of taper is approximately 10 degrees relative to the vertical plane, though this is merely optional. In some versions, the angle of taper may comprise an angle of 5 degrees, inclusive, to 15 degrees, inclusive. It should be understood that the angle of taper may comprise an angle of slightly greater than 0 degrees, inclusive, to slightly less than 90 degrees, inclusive. Of course, it should be understood that interior surface (132) need not necessarily include a constant angle of taper along the entirety of interior surface (132); rather, interior surface (132) may simply include a flat portion or segment that contacts ball member (150) at a desired point or points on an outer surface (152) of ball member (150). In some versions, interior surface (132) may comprise, at least in part, a concave semi-spherical surface that is complementary to ball member (150), though this is also optional. Still other geometrical arrangements for interior surface (132) will be apparent to one of ordinary skill in the art in view of the teachings herein.

Outer surface (152) of ball member (150) contacts interior surface (132) at a latitude on ball member (150) that is at an angle below the equatorial latitude of ball member (150) equal to the angle of the taper, which is approximately 10 degrees in this example, though this is also merely optional. It should be understood that, with a constant angle of taper, the annular interface region of ball member (150) with interior surface (132) remains substantially constant even with minor size variations between ball member (150) and interior surface (132). The engagement of outer surface (152) with interior surface (132) in the present example occurs at a nearly vertical portion of each such that the surface area where the two surfaces (132, 152) engage is larger than if the engagement occurred at a lower angled region.

Accordingly, the frictional resistance between the two surfaces (132, 152) is increased due to the mechanical advantage of the narrow angle taper a in socket portion (130), which causes the contact forces between ball member (150) and socket portion (130) to be greater than the weight of the supported load. For instance, the weight of fan (10) may create a wedging action between ball member (150) and interior surface (132) to provide resistance and/or damping to rotation and/or movement of ball member (150) relative to socket portion (130). Thus, this annular interface region of outer surface (152) of ball member (150) and interior surface (132) provides frictional resistance to the rotation and/or movement of ball member (150) relative to socket portion (130). Of course, it should be understood that the foregoing is merely exemplary and, in some versions, lower angles and/or regions for engagement of the two surfaces (132, 152) may be used.

In addition, or in the alternative, interior surface (132) may include surface features that provide additional resistance to the rotation and/or movement of ball member (150). In the present example, a plurality of vertical channels (138) are disposed in an annular array about interior surface (132). Vertical channels (138) form discontinuity points about interior surface (132) such that the edges of vertical channels (138) provide additional resistance to the rotation and/or movement of ball member (150). In addition, or in the alternative, to vertical channels (138), other features may be provided on interior surface (132) as well. By way of example only, pebbling, scallops, dimples, divots, scoring, ridging, and/or other features for interior surface (132) will be apparent to one of ordinary skill in the art in view of the teachings herein.

Moreover, in some versions, the material for socket portion (130) may comprise a material having a high coefficient of friction (e.g., rubber, latex, polymers, etc.) or may otherwise be selected to provide additional resistance to rotation and/or movement of ball member (150) relative to socket portion (130), though this is optional. It should be understood that the foregoing features of socket portion (130) are configured to resist slight and/or unintentional movement of ball member (150) relative to socket portion (130) while still permitting substantial intentional rotational freedom of ball member (150) relative to socket (130). For example, such features may provide resistance to, or damping of, swaying or oscillation of fan (10) caused by an imperfectly balanced fan (10) and/or features of fan (10) and/or where a slight breeze or impact moves fan (10). Of course, still other configurations for socket portion (130) and/or mount (110) will be apparent to one of ordinary skill in the art in view of the teachings herein.

A tab (136) extends inwardly from interior surface (132) opposite of open section (140), though this is merely optional. In the present example, tab (136) is insertable into a channel (156) formed along a vertical portion of outer surface (152) of ball member (150), such as that shown in FIG. 2. Tab (136) of the present example is sized and vertically positioned relative to a lower surface of socket portion (130) such that tab (136) does not abut or otherwise interfere with support (12) when ball member (150) and support (12) are rotated within socket portion (130). Channel (156) of the present example comprises a groove or other indentation formed in ball member (150) that is sized to receive tab (136) therein.

The channel (156) may extend vertically along outer surface (152) of ball member (150) from a top portion of ball member (150) and terminates at an intersection with vertical passage (158) such that a curved channel is formed on ball member (150). With tab (136) inserted into channel (156), tab (136) resists rotation of ball member (150) about a vertical axis extending through support (12) while permitting ball member (150) to rotate within the plane formed by channel (156). Accordingly, in some versions, when motor (22) is running, tab (136) and channel (156) may cooperatively resist rotation of ball member (150) and support (12) relative to mount (110). Of course, it should be understood that tab (136) and/or channel (156) may be omitted in some versions. Further configurations for tab (136) and/or channel (156) will be apparent to one of ordinary skill in the art in view of the teachings herein.

As noted previously, ball member (150) is coupled to an end of support (12) opposite fan (10). In the present example, ball member (150) comprises a polymer-based hemispherical ball having a vertical passage (158) extending through ball member (150) and configured to receive and secure support (12) therein, as will be described below. Ball member (150) is configured to interface with socket portion (130) and interior surface (132) to provide a rotatable joint. While interior surface (132) includes a number of features for providing frictional or other resistance to movement and/or rotation of ball member (150) relative to socket portion (130), in some versions ball member (150) may include one or more features to provide frictional or other resistance to movement and/or rotation of ball member (150) relative to socket portion (130) in addition or in the alternative to the features associated with interior surface (132). For instance, in some versions ball member (150) may include pebbling, scallops, dimples, divots, scoring, ridging, and/or other features on an outer surface (152) of ball member (150).

In addition, or in the alternative, the material for ball member (150) and/or for a thin layer disposed on outer surface (152) may comprise a material having a relatively high coefficient of friction (e.g., rubber, latex, polymers, etc.) or may otherwise be selected to provide additional resistance to rotation and/or movement of ball member (150) relative to socket portion (130), though this is discretionary. As with the features of socket portion (130), it should be understood that the foregoing features of ball member (150) are configured to resist slight and/or unintentional movement of ball member (150) relative to socket portion (130) while still permitting substantial intentional rotational freedom of ball member (150) relative to socket (130). For example, such features may provide resistance to, or damping of, swaying or oscillation of fan (10) caused by an imperfectly balanced fan (10) and/or features of fan (10) and/or where a slight breeze or impact moves fan (10). Of course, still other features for ball member (150) will be apparent to one of ordinary skill in the art in view of the teachings herein.

In the present example, the body of ball member (150) is generally hemispherical. It should be understood, however, that the body of ball member (150) need not necessarily be shaped like exactly half of a sphere, and may instead be shaped like any portion of a sphere, or “partially” spherical. Furthermore, the body of ball member (150) may be shaped like an entire sphere. In view of this, use of terms such as “hemispherical” or “spherical” herein should not be read as being limited to exactly half of a sphere or a full sphere. A “spherical member” may in fact be shaped like just a hemisphere or some other portion of a full sphere. Similarly, a “partially spherical member” may in fact be shaped like a full sphere.

As noted above, support (12) is received in vertical passage (158) of ball member (150) such that support (12) is securely coupled to ball member (150). In the present example, support (12) includes a pair of transverse holes (196) configured to receive a pin (198) therein, as shown in FIG. 2. A fastener (190) may also be provided for connecting the ball member (150) to the support (12) in a conventional manner.

To further restrict potential rotation and/or movement of the fan (10), particularly in environments in which the fan may be subject to excessive swaying that cannot be abated using the foregoing approaches, a modular restrictor (200) may be implemented. In one embodiment, as illustrated in FIGS. 3-5, the restrictor (200) comprises an assembly of two (or more) restrictor portions or halves (220a, 220b) for interacting with the mounting assembly (100) to dampen further the side-to-side movement or sway of the fan (10).

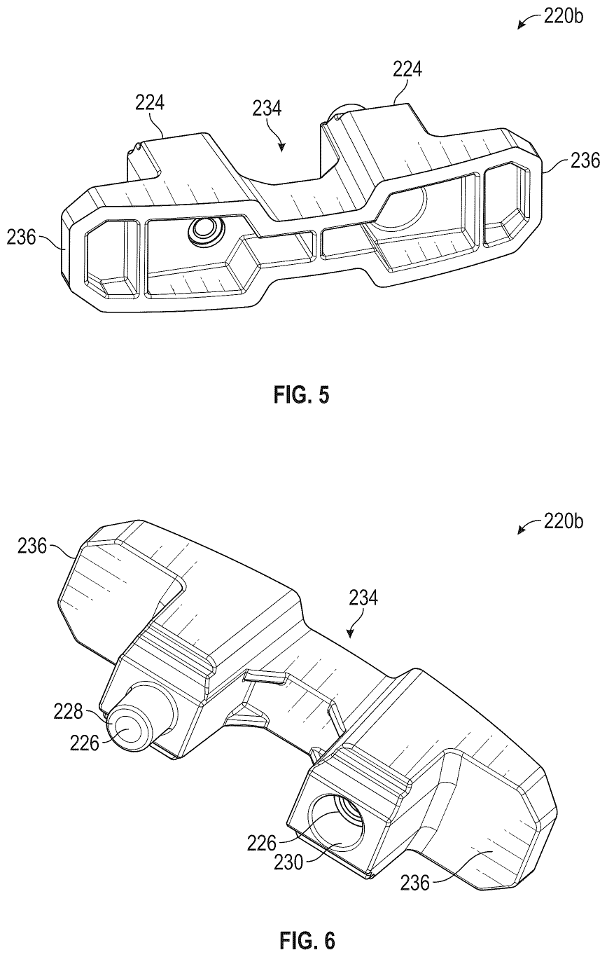

The portions (220a, 220b) of the assembly in the illustrated version are generally U-shaped in plan view (see portion 220b in FIG. 5), and thus the resulting annular assembly forms a central passage when coupled together. Each portion (220a, 220b) includes a pair of spaced extensions (224) that, in the operative position, project generally transverse to a central axis of the mounting assembly (100) and support (12), thus bounding the central passage. One or more lateral passages (226) may be provided for receiving one or more fasteners (F) for coupling the portions (220a, 220b) together to form the modular restrictor (200). In the illustrated version, two such passages (226) are provided, each for receiving one fastener (F), but any number may be provided to form a secure assembly. Alternatively, the fasteners (F) may be integral with the portions (220a, 220b).

The inboard ends of the extensions (224) of each portion (220a, 220b) of the assembly (220) may also be provided with locators to ensure proper alignment when assembled (see portion 220b in FIG. 6). Specifically, an annular projection (228) may surround the passage (226) on one extension (224), and a corresponding recess (230) may surround the passage (226) on the other extension. The arrangement may be repeated for both portions (220a, 220b). In this manner, proper coupling and alignment may be readily achieved when the portions (220a, 220b) are associated with the mounting assembly (100), such as when inserted between the stanchions (126) at a location above the upper surface of the ball member (150).

As shown best in FIG. 3, the modular restrictor (200) may be inserted into the socket portion (130) of the mounting assembly (100) such that it engages the ball member (150). This positioning may be below an associated power source P (broken line depiction in FIG. 3C) for powering the fan (10), which thus serves to limit the movement of the restrictor (200) in the vertical direction. The portions (220a, 220b) of the restrictor assembly (200) may be made of a dimensionally stable material, such as a rigid polymer (an example of which is an injection molded Nylon material). A material having a Young's Modulus of greater than 1 GPa is preferred.

When assembled, the modular restrictor (200) may form a central passage (232) for electrical cables and other wiring required for operation of the fan (10). As best demonstrated by FIGS. 3A, 3B, and 5, this passage (232) may be provided by a channel (234) formed in one portion (220b) of the assembly (220). This channel (234) may be open at both the outboard and inboard ends of the portion (220b) to allow for passage of the cables or wiring from a location inside or within the mounting assembly (100) to a location outside the mounting assembly (such as the upper end of support (12) in communication with the central passage (232) as a result; see FIGS. 3A and 3B).

The width of each portion (220a, 220b) may be less than the width of the space between the stanchions (126) to allow for passage into the mounting assembly (100) and consequently positioning adjacent to the ball member (150). In the particular version illustrated, the outer lateral faces of the extensions (224) are arranged so as to abut with an adjacent inner surface of the stanchion (126). As can be understood from FIGS. 3A and 6, the portions (220a, 220b) of the modular restrictor (200) may also include lips (236) for abutting with an outer surface of the stanchion (126) and thus form a secure assembly when fastened together.

Comparing FIG. 2 with FIG. 4, it can be understood that the stanchions (126) in the latter may comprise multiple legs (126a, 126b), which are spaced apart. A connector (238) may connect each pair of the legs (126a, 126b). Each connector (238) may be adapted to resist vertical movement of the modular restrictor (200) when positioned therein. This may be achieved, for instance, by passing a fastener (F) through aligned apertures in opposed connectors.

A corresponding groove may be provided in the restrictor (200) for at least partially receiving the fasteners (F). As perhaps best understood from FIGS. 5 and 6, each portion of the restrictor (200) may include part of the groove, which may extend along the uppermost surface in the mounted condition.

In use, the fan (10) may be subject to swaying as a consequence of external forces, such as wind to a degree that cannot be foreclosed by the frictional engagement of the ball (150) with the socket portion (130). In such case, the ball (150) engages the modular restrictor (200) and excessive or undesirable sway is thus prevented. The modular restrictor (200) thus provides a counteracting force limiting the degree to which the fan (10) may oscillate or sway.

When it is necessary to connect the power source (P) to the fan motor (22) or another accessory, via the support (12), portion 220b, of the restrictor 200 may be removed, as shown in FIG. 3B, such as by withdrawing the corresponding fasteners (F) and urging it radially outwardly. This removal of portion (220b) provides access to the upper end of the support (12) without the need to remove the power source (P) from the mounting assembly (100). The wiring may then pass through the channel (234) forming radially extending passage (232) in the portion (220b) when returned to the assembled position with portion (220a) to form restrictor (200).

As can be appreciated, the modular restrictor (200) is especially well-adapted for being retrofitted into existing fan mounts comprising ball and socket types of arrangements. An installer may simply insert the portions (220a, 220b) forming the restrictor (200) into the mounting assembly (100) without the need to dismount the same from the ceiling or the like, and the desired anti-sway capabilities may be achieved. Furthermore, should the restrictor (200) deteriorate over time, it can be easily replaced in whole or in part. Likewise, if a particular restrictor (200) is deemed inadequate to reduce the sway to an acceptable level, one formed of a less resilient or harder material may be used as a replacement.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not necessarily required. Accordingly, the scope of the present invention should be considered in terms of the claims and is understood not to be limited to the details of structure and operation shown and described in the specification and drawings.

1. An apparatus for mounting a fan, comprising;
a fan mount for supporting the fan, the fan mount comprising a first part movable relative to a second part; and
a modular restrictor connected to the second part of the fan mount above the first part for restricting the movement of the fan relative to the fan mount, the modular restrictor comprising first and second interconnected portions adapted for engaging the second part.

2. The apparatus of claim 1, wherein the first part comprises a partially spherical ball and the second part comprises a socket for at least partially receiving the partially spherical ball, the modular restrictor being positioned in the fan mount for engaging an upper surface of the partially spherical ball.

3. The apparatus of claim 1, wherein each portion of the restrictor includes at least one passage for receiving a fastener.

4. The apparatus of claim 1, wherein at least one portion of the restrictor includes a channel.

5. The apparatus of claim 1, wherein each portion of the restrictor includes a locator for ensuring proper alignment when assembled.

6. The apparatus of claim 1, wherein the second part comprises at least one stanchion, and at least one of the portions of the modular restrictor is adapted for engaging the at least one stanchion.

7. The apparatus of claim 1, wherein each portion of the modular restrictor is generally U-shaped in plan view.

8. The apparatus of claim 1, wherein the modular restrictor comprises a resilient material.

9. The apparatus of claim 1, wherein the modular restrictor is adadpted for engaging a fastener associated with the fan mount.

10. An apparatus for mounting a fan, comprising:
a fan mount for supporting the fan, the fan mount comprising a first part movable relative to a second part; and
a modular restrictor positioned above the first part for restricting the movement of the fan relative to the fan mount, the modular restrictor comprising first and second interconnected portions together forming a central passage for allowing a wire or cable to extend into the fan mount.

11. The apparatus of claim 10, wherein the first part comprises a partially spherical ball and the second part comprises a socket for at least partially receiving the partially spherical ball, the modular restrictor being positioned in the fan mount for engaging an upper surface of the partially spherical ball.

12. The apparatus of claim 10, wherein each portion of the restrictor includes at least one passage for receiving a fastener.

13. The apparatus of claim 10, wherein each portion of the restrictor includes a locator for ensuring proper alignment when assembled.

14. The apparatus of claim 10, wherein the second part comprises at least one stanchion, and at least one of the portions of the modular restrictor is adapted for engaging the at least one stanchion.

15. The apparatus of claim 9, wherein at least one portion of the modular restrictor is generally U-shaped in plan view.

16. The apparatus of claim 9, wherein the modular restrictor comprises a resilient material.

17. The apparatus of claim 1, wherein at least one portion of the restrictor includes a channel.

18. A method of controlling sway of a fan relative to a fan mount comprising a first part connected to a support for supporting the fan, the first part being movable relative to a second part, comprising:
interconnecting first and second portions of a modular restrictor; and
positioning the modular restrictor in a position to restrict movement of the first part relative to the second part.

19. The method of claim 18, further including the step of passing wiring through a passage of the modular restrictor.

20. The method of claim 18, further including the step of mounting the fan to a ceiling prior to the positioning step.
